(19) United States
(12) Patent Application Publication
(10) Pub. No.: US 2014/0304001 A1
(43) Pub. Date: Oct. 9, 2014

(54) APPARATUS AND METHOD FOR PATIENT CARE DOCUMENTATION

(71) Applicant: LG CNS CO., LTD., Seoul (KR)

(72) Inventors: Kwan Pyo LEE, Seoul (KR); In Ho CHOI, Seoul (KR); Jong Hun PARK, Seoul (KR); Joong Yong PARK, Seoul (KR); Sung Ho KIM, Seoul (KR); Moon Ho HA, Seoul (KR)

(73) Assignee: LG CNS CO., LTD., Seoul (KR)

(21) Appl. No.: 14/139,451

(22) Filed: Dec. 23, 2013

Related U.S. Application Data
(60) Provisional application No. 61/809,249, filed on Apr. 5, 2013.

(51) Int. Cl. G06F 19/00

(52) U.S. Cl. CPC G06F 19/322
USPC 705/3

(57) ABSTRACT

A patient care documentation method includes receiving care task data including user-undertaken care tasks from a patient care documentation server, receiving an answer selected in response to a text query or a symbolic answer selected from a plurality of symbolic expressions, the text query or the plurality of symbolic expressions corresponding to processes of performing the user-undertaken care tasks and providing the received answer or symbolic answer to the patient care documentation server.

### CROSS-REFERENCE TO RELATED APPLICATION

The present application is a non-provisional of and claims priority to U.S. Provisional Application No. 61/809,249 filed Apr. 5, 2013.

### BACKGROUND OF THE INVENTION

1. Field of the Invention

The present invention relates to a technique of documenting patient care records, and more particularly, to a patient care documentation apparatus and method of managing a patient care service.

2. Related Art

In health care settings, such as nursing facilities, nursing care providers are supposed to store patient care records on services provided to patients. In related arts, Patient care records are stored by recording a health care professional's verbal notes, which a voice recognition device analyzes. After analyzing the recorded voice, the voice recognition device stores details of the services provided to the patient. These details are used to charge the patient or a guardian thereof for the services afterwards.

U.S. Patent Publication No. 2011/0040564 discloses a voice assistant system for assisting a care provider in the documentation of self-performance and support information for a resident or patient of a nursing or health care facility. This system is able to accurately capture activity information about the resident or patient to document information regarding activities of daily living (ADL).

U.S. Patent Publication No. 2012/0136667 discloses a voice assistant system for storing a care plan for a resident or patient. In this system, a dedicated terminal, e.g., a voice assistant terminal, may provide voice outputs to a user, e.g., a certified nursing assistant (CNA), to provide information on task activities received from a central system. The dedicated terminal sequentially receives inputs from the user by voice recognition (VR).

According to the related art, medical services are recorded primarily through text-to-speech (TTS) and speech-to-text (STT) technologies. Thus, if the recorded speech is not clearly recognized by a voice recognition device due to noise or the like, provided services may not be charged. Also, since the voice recognition device analyzes each word, a considerable time may be required for the voice recognition.

### SUMMARY OF THE INVENTION

Embodiments of the present invention provide a patient care documentation method that efficiently manages records on patient care tasks, which are tasks that a health care professional undertakes to provide care to a patient, through a computing device.

Embodiments of the present invention also provide a patient care documentation method of performing patient care documentation using a series of questions and answers, which may include symbolic answers.

In addition, embodiments of the present invention provide a patient care documentation method that assists in providing a medical service to a patient within an appropriate time by assisting a user, i.e., a health care professional or care provider, in performing a care task that the user has undertaken for the patient (a user-undertaken care task).

According to an aspect of the present invention, there is provided a patient care documentation method including receiving care task data including user-undertaken care tasks from a patient care documentation server, receiving a selected answer in response to a text query or a symbolic answer selected from a plurality of symbolic expressions, the text query or the plurality of symbolic expressions corresponding to processes of performing the user-undertaken care tasks, and transmitting the selected answer or symbolic answer to the patient care documentation server.

The care task data may include at least one of a personal care schedule and a periodic care schedule associated with the user-undertaken care task.

Receiving the care task data may include prompting selection of a particular patient among patients assigned to a user through the personal care schedule, and receiving user-undertaken care tasks for the particular patient from the patient care documentation server when the particular patient is selected.

Receiving the care task data may include prompting selection of a certain patient care time through the periodic care schedule, and receiving user-undertaken care tasks for a particular patient to be performed at the certain patient care time from the patient care documentation server when the certain patient care time for the particular patient is selected.

Receiving the selected answer may include receiving a plurality of selected answers from a user in response to a corresponding progression of text queries regarding the user-undertaken care tasks on the basis of a predefined query and answer progression.

Receiving the selected answer may further include, when a change request with respect to the received plurality of selected answers is received from the user, generating an upper node for the predefined query and answer progression through a text query.

Receiving the selected answer may further include determining one of leaf nodes for the predefined query and answer progression as the selected answer based on the received plurality of selected answers, and determining a care task performance code.

Receiving the selected answer may include checking whether or not a portion of the text queries has been formatted in a particular form, and when it is determined that the portion of the text queries has been formatted in the particular form, detecting a formal language through the particular form and rendering a modified text query according to the detected formal language.

The patient care documentation method may further include tagging a process time of the user-undertaken care tasks to the care task performance code.

Receiving the symbolic answer may include receiving one of the plurality of symbolic expressions through a query and answer progression with respect to the user-undertaken care tasks.

Receiving the symbolic answer may further include providing leaf nodes in the query and answer progression as the plurality of symbolic expressions.

The patient care documentation method may further include tagging a process time of the user-undertaken care tasks to a care task performance code.

The patient care documentation method may further include if a late care service message with respect to the user-undertaken care tasks is received from the patient care documentation server, requesting a user to perform a late care service by changing a device state.

The patient care documentation method may further include, if there is a certain user-undertaken care task that is not performed for a particular period of time and an urgent care service message with respect to the certain user-undertaken care task is received from patient care documentation server, requesting a user to perform an urgent care service by changing a device state.

The patient care documentation method may further include providing assistance records with respect to the user-undertaken care tasks through at least one of text and speech to the patient care documentation server.

The patient care documentation method may further include performing user authentication with a user through the patient care documentation server before receiving the care task data.

According to another aspect of the present invention, there is provided a system for generating patient care documentation, the system including a processor, a network interface, a user interface, and a non-transitory computer readable medium including instructions for performing the following steps of receiving care task data including user-undertaken care tasks from a patient care documentation server and displaying the care task data, receiving an answer selected in response to a text query in a query and answer progression or a symbolic answer selected from a plurality of symbolic expressions, the text query or the plurality of symbolic expressions corresponding to processes of performing the user-undertaken care tasks, and providing the received answer or symbolic answer to the patient care documentation server.

The non-transitory computer readable medium may further include instructions for requesting the user to perform a late care service by changing a device state when a late care service message with respect to the user-undertaken care tasks is received from the patient care documentation server.

The non-transitory computer readable medium may further include instructions for receiving an urgent care service message with respect to a certain user-undertaken care task from the patient care documentation server when the certain user-undertaken care task is not performed for a particular period of time, and requesting the user to perform an urgent care service by changing a device state.

According to still another aspect of the present invention, there is provided a computer readable medium having a computer program for causing a computer to perform patient care documentation, the computer readable medium including code for receiving care task data including user-undertaken care tasks from a patient care documentation server, code for receiving an answer selected in response to a text query in a query and answer progression or a symbolic answer selected from a plurality of symbolic expressions, the text query or the plurality of symbolic expressions corresponding to processes of performing the user-undertaken care tasks, and code for providing the received answer or symbolic answer to the patient care documentation server.

In embodiments of the present invention, patient care tasks can be effectively managed through a computing device.

In embodiments of the present invention, patient care documentation can be managed through a series of questions and answers, which may be a flow answer or a symbolic answer, without relying primarily on speech, through a computing device.

In embodiments of the present invention, a medical service for a patient can be provided within an appropriate time by assisting user-undertaken care tasks.

### BRIEF DESCRIPTION OF THE DRAWINGS

The above and other objects and features of the present invention will become apparent from the following description of embodiments given in conjunction with the accompanying drawings, in which:

FIG. 1 illustrates a patient care documentation system according to an embodiment of the present invention.

FIG. 2A illustrates a simplified view of a patient care documentation device according to an embodiment of the present invention.

FIG. 2B illustrates a block diagram of a patient care documentation device according to an embodiment of the present invention.

FIG. 3 illustrates a screen of a user log-in process displayed on a patient care documentation device according to an embodiment of the present invention.

FIG. 4 illustrates a screen showing an arrangement of care task data displayed on a patient care documentation device for a care scheduling and documentation process according to an embodiment of the present invention.

FIGS. 5A and 5B illustrate screens displaying care task data after selecting a personal care schedule field shown in FIG. 4.

FIG. 6 illustrates a screen displaying care task data after selecting a periodic care schedule field shown in FIG. 4.

FIGS. 7A and 7B illustrate screens of care task data after selecting a restorative schedule field shown in FIG. 4.

FIGS. 8A and 8B illustrate screens of care task data after selecting an all information field and an incomplete information field of FIG. 4, respectively.

FIG. 9 illustrates a screen displayed after a message field of FIG. 4 is selected.

FIGS. 10A through 10C illustrate screens displayed on a patient care documentation device in a method of patient care documentation according to an embodiment of the present invention.

FIG. 11 illustrates a screen displayed on a patient care documentation device in a method of patient care documentation according to an embodiment of the present invention.

FIG. 12 illustrates a screen including symbolic expressions displayed on a patient care documentation device in a method of patient care documentation according to an embodiment of the present invention.

FIG. 13 is a flow chart illustrating a patient care documentation method according to an embodiment of the present invention.

FIG. 14 is a detailed flow chart illustrating a patient care documentation method according to an embodiment of the present invention.

### DESCRIPTION OF THE EMBODIMENTS

In the present disclosure, descriptions of embodiments of the present invention provide structural and functional explanations. The scope of the present invention should not be limited to the embodiments described in the specification. That is, since embodiments may be implemented in several forms without departing from the spirit and scope of the present invention, it will be understood that embodiments of the present invention are not limited by details of the description provided herein, unless otherwise specified. Rather, embodiments of the present invention should be construed broadly within the scope defined by the appended claims. Therefore, various changes and modifications that fall within the scope of the claims, or equivalents of such scope, are therefore intended to be embraced by the appended claims.

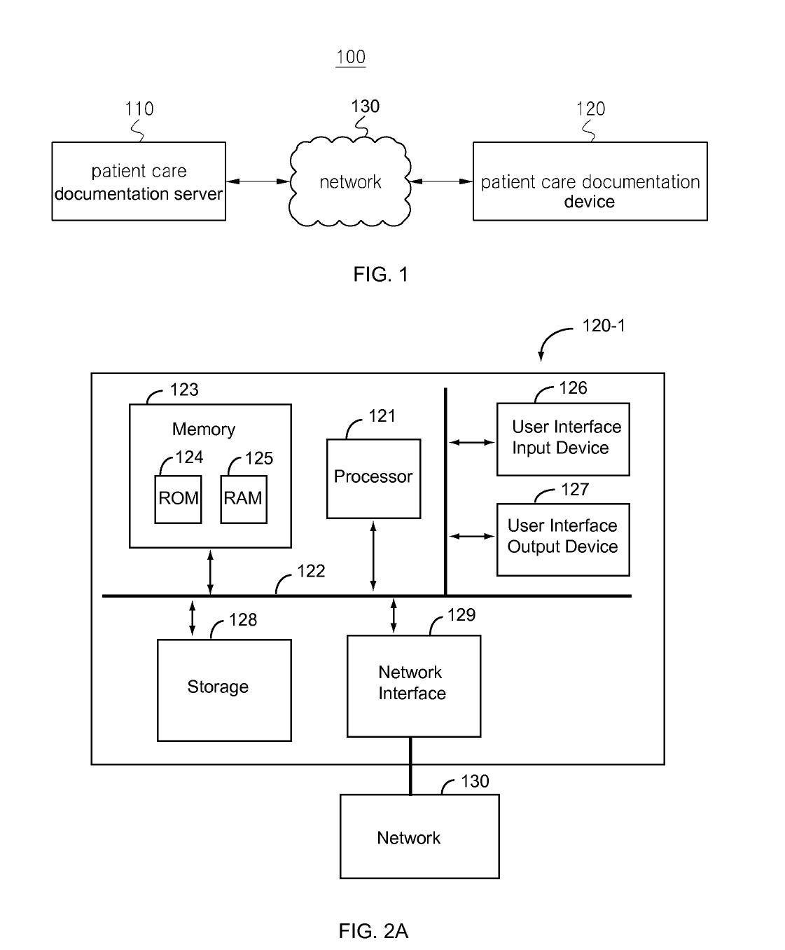

FIG. 1 illustrates a patient care documentation system according to an embodiment of the present invention. The patient care documentation system 100 includes a patient care documentation server 110 and a patient care documentation device 120.

The patient care documentation server 110 manages care tasks that are to be provided to and have been provided to a patient or a person resident at a nursing facility. Care tasks may include an activities of daily living (ADL) service, a vital service, a restorative service, and the like. The patient care documentation server 110 is coupled to the patient care documentation device 120 via a network 130 to transmit and receive care task data to and from the patient care documentation device 120.

In an embodiment, the patient care documentation server 110 is implemented in a cloud computing environment to receive information on a user interface (UI) from the patient care documentation device 120.

The patient care documentation server 110 generates a minimum data set code (MDS) to collect Resource Utilization Group (RUG) values used to calculate fees for services provided to the patient. In an embodiment, the patient care documentation server 110 transmits and receives a dynamic document to and from the patient care documentation device 120 through a software architecture (e.g., Restful API), and generates a patient care documentation based on the dynamic document from the patient care documentation device 120.

The patient care documentation device 120 may provide a touch sensitive user interface, e.g., a touchscreen, to a user. In an implementation, the user is a care provider. Care task data, including user-undertaken care tasks, are managed through the user interface on the basis of a point of care document (PoCD). Herein, the user may be a health care professional, such as a certified nursing assistant (CNA), who provides care to a patient or person resident at a nursing facility.

In an embodiment, the patient care documentation device 120 is coupled to the patient care documentation server 110 via the network 130. The patient care documentation device 120 may include a desktop computer, a laptop computer, a smart phone, a tablet personal computer (PC), an all-in-one computer, or any other computing device that is suitable for providing patient care documentation. In an embodiment, the patient care documentation device 120 is operable in the cloud computing environment. For example, one or more software aspects of the patient document may be provided in the cloud and may be accessed by a physical computing device being used by a user to implement various embodiments of the present invention.

The network 130 may be a wired or wireless communication network. Examples of the wireless network include Wi-Fi, 3G, and LTE.

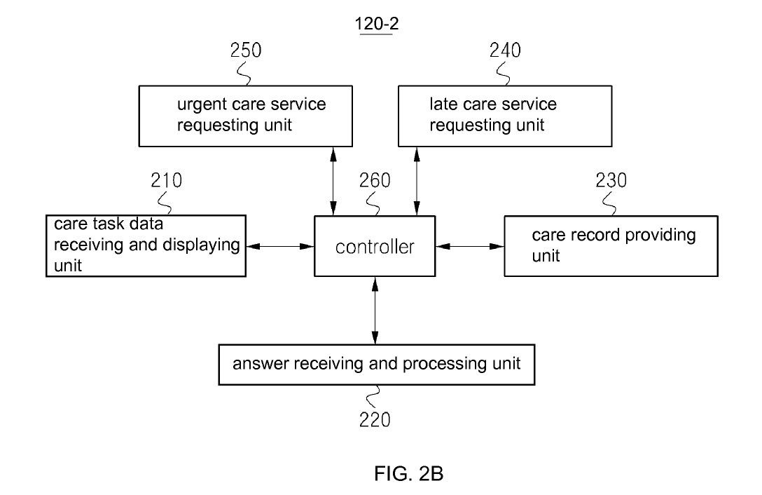

FIG. 2A illustrates a simplified view of a patient care documentation device 120-1 according to an embodiment of the present invention. The patient care documentation device 120-1 includes a processor or CPU 121 that is in communication with a variety of other components via a bus 122. Such other components of the patient care documentation device 120-1 include, but are not limited to, a non-transitory computer readable storage medium as a memory 123, including a read only memory (ROM) 124 and a random access memory (RAM) 125, and also a higher capacity non-transitory computer readable storage medium 128.

One or more of these components may be employed by the patient care documentation device 120-1 to store computer code including instructions for patient care documentation. This computer code may be received from the patient care documentation server 110 over the network 130 to allow the user to provide and receive care task data for the patient care documentation.

The user may communicate with the patient care documentation device 120-1 via a user interface input device 126 such as a keyboard, pointing devices such as a mouse, trackball, touchpad, or graphics tablet, a scanner, a barcode scanner for scanning item barcodes, a touchscreen incorporated into a display, or other types of input devices. In general, use of the term “input device” is intended to include all possible, mechanisms for inputting information into the patient care documentation device 120-1 or onto the network 130.

The user may receive information from the patient care documentation device 120-1 via a user interface output device 127. The user interface output device 127 may include a visual output device, such as a display screen, but is not limited thereto. The term “output device” is intended to include all possible mechanisms for outputting information to a user, and may include a visual output device alone, or in combination with any of an auditory output device, such as a speaker, and a haptic output device. Information output to the user may include information on the patient care documentation.

In an embodiment, the display screen may be a touchscreen that both displays the information from the patient care documentation device 120-1 and receives inputs from the user. That is, the display screen may act as a user interface input device and a user interface output device. In an embodiment, the patient care documentation device 120-1 may include a sensing unit (not shown) that senses inputs provided through, for example, a touchscreen, including but not limited to swiping motions made on the touchscreen.

The patient care documentation device 120-1 also includes a network interface element 129. This network interface element 129 is configured to allow information to be communicated between the patient care documentation device 120-1 and the network 130. Such information may include the code that is executable on the patient care documentation device 120-1, care task data from the patient care documentation server 110, and records on care tasks applied to the patient.

FIG. 2B is a block diagram of a patient care documentation device 120-2 according to an embodiment of the present invention.

In an embodiment, the patient care documentation device 120-2 may be implemented as a dedicated terminal used only for the patient care documentation. In another embodiment, the components shown in FIG. 2B may be implemented using the components of the patient care documentation device 120-1 shown in FIG. 2A.

Referring to FIG. 2B, the patient care documentation device 120-2 includes a care task data receiving and displaying unit 210, an answer receiving and processing unit (or answer processor) 220, a care record providing unit 230, and a late care service requesting unit 240, an urgent care service requesting unit 250, and a controller 260. The controller 260 may be implemented as software, hardware or in a combination thereof depending on implementation. If implemented as hardware, the controller 260 may be implemented by the processor 121 (or CPU) illustrated in FIG. 2A. Similarly, other units in the patient care documentation device 120-2 may be implemented as software, hardware or a combination thereof depending on implementation. In an embodiment, the care task data receiving and displaying unit 210, the answer receiving and processing unit 220, the care record providing unit 230, the late care service requesting unit 240, and the urgent care service requesting unit 250 are software modules and are stored in the computer readable medium, e.g., the storage 128 or the memory 123. One or more of these may also be stored remotely and accessed by the patient care documentation device 120-2 via a network (e.g., the network 130).

The care task data receiving and displaying unit 210 receives care task data including a user-undertaken care task from the patient care documentation server 110. The user-undertaken care task includes at least one of a name of a patient, the number of times to perform the user-undertaken care task, and a time when the user-undertaken care task should be performed. The care task data may be displayed using at least one of a personal care schedule and a periodic care schedule with respect to the user-undertaken care task.

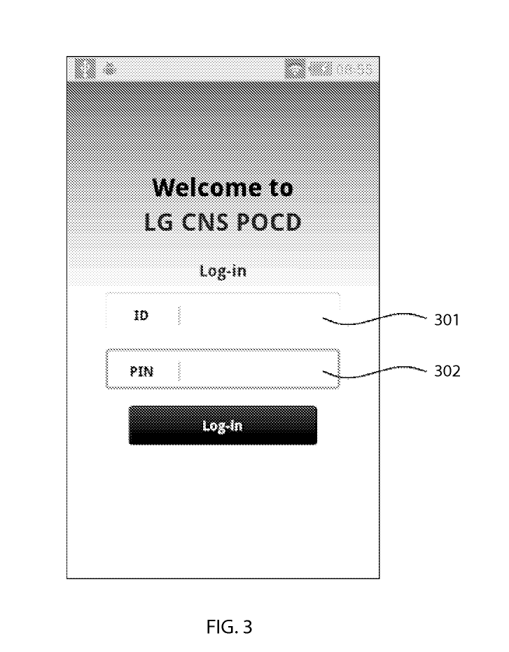

FIGS. 3-9 are screens illustrating features of embodiments of the present invention.

Referring to FIG. 3, in an embodiment, after a user, e.g., a care provider, is authenticated by the patient care documentation server 110, the care task data receiving and displaying unit 210 receives the care task data from the patient care documentation server 110. For example, when log-in information including a user identification (ID) 301 and a user password (e.g., personal identification number (PIN)) 302 is provided by the user using a user log-in screen shown in FIG. 3, the patient care documentation server 110 performs user authentication. After the user authentication is successfully achieved, the care task data receiving and displaying unit 210 receives the care task data from the patient care documentation server 110 and displays the care task data.

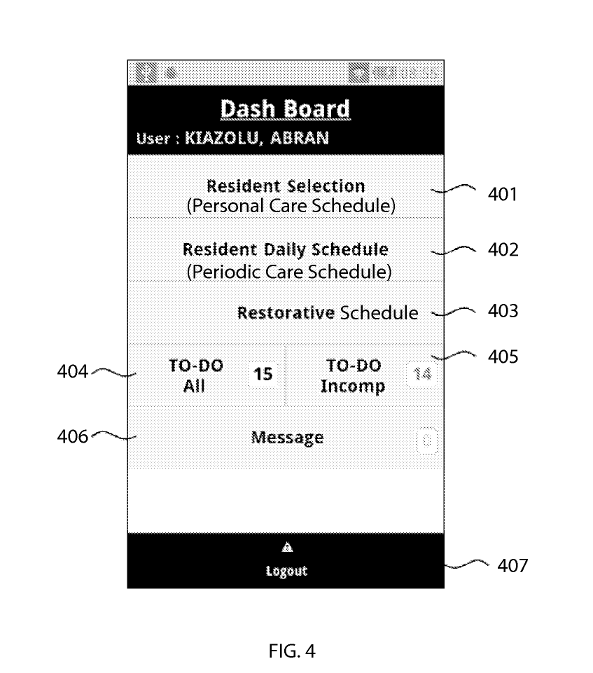

In an embodiment, referring to FIG. 4, the care task data and related data may be displayed using a plurality of fields. In the embodiment shown in FIG. 4, examples of such fields include a Resident Selection 401, a Resident Daily Schedule 402, a Restorative Schedule 403, a To-Do All 404 field, a To-Do Incomplete 405 field, and a Message 406 field. However, one of skill in the art will understand that embodiments of the present invention are not limited to a nursing care or in-patient health care facility. Thus, hereinafter, these fields will be referred to more broadly with reference to the information represented by each.

For example, a personal care schedule, e.g., the Resident Selection 401, allows a user to individually select a patient or resident to whom care is to be provided; a periodic care schedule, e.g., the Resident Daily Schedule 402, provides information regarding user-undertaken tasks to be performed during a predetermined period of time; a restorative schedule, e.g., the Restorative Schedule 403, indicates user-undertaken tasks for restoring a patient's health; an all information field, e.g., the To-Do All 404 field, indicates all user-undertaken care tasks assigned to the user; an incomplete information field, e.g., the To-Do In complete 405 field, includes user-undertaken care tasks that have not been completed; and a message field, e.g., the Message 406 field, allows a user to communicate with other users. Selection of log-out control 407, shown at the bottom of FIG. 4, causes the care task data receiving and displaying unit 210 to display the user log-in screen of FIG. 3 again.

The personal care schedule 401, the periodic care schedule 402, the restorative schedule 403, the all information field 404, the incomplete information field 405, and the message field 406 shown in FIG. 4 may be selectively activated by the user. Selection of any of these fields causes the patient care documentation server 110 to provide information corresponding to the selection. Each selection will be described further below, with reference to FIGS. 4-9.

In an embodiment, the user selects a particular patient from a plurality of patients assigned to the user through the personal care schedule 401. The care task data receiving and displaying unit 210 receives user-undertaken care tasks for the particular patient from the patient care documentation server 110 and displays the received tasks.

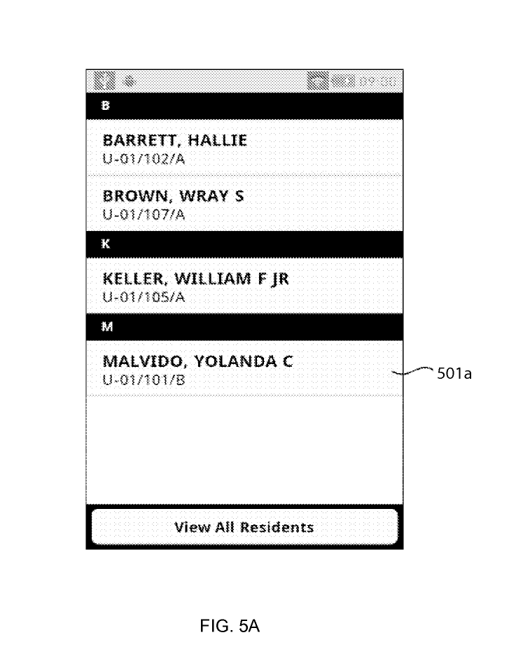

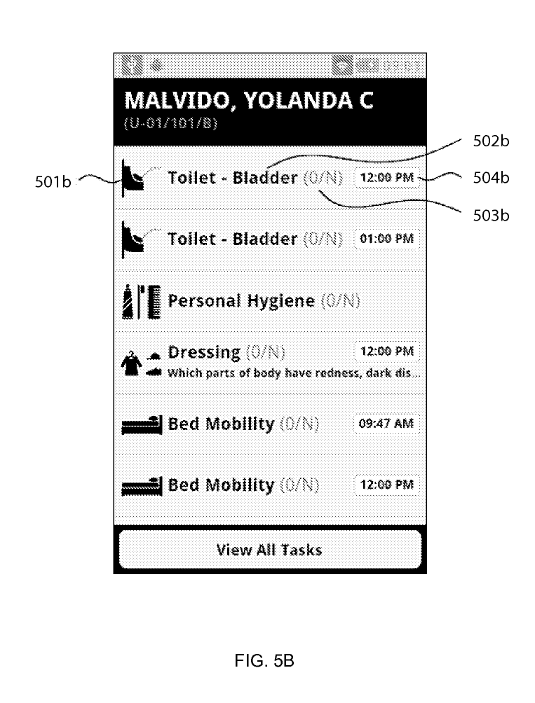

Referring to FIGS. 5A and 5B, when MALVIDO, YOLANDA C 501a is selected from among the patients included in the list shown in FIG. 5A, which is displayed after selecting the personal care schedule 401 (FIG. 4), the patient care receiving and displaying unit 210 displays user-undertaken care tasks for the particular patient MALVIDO, YOLANDA C as illustrated in FIG. 5B. Display of the user-undertaken care tasks may include at least one of an icon 501b indicating a corresponding user-undertaken care task, a name 502b of the corresponding user-undertaken care task, the number of times 503b for performing the corresponding user-undertaken care task, and a specific time 504b when the corresponding user-undertaking care task should be performed.

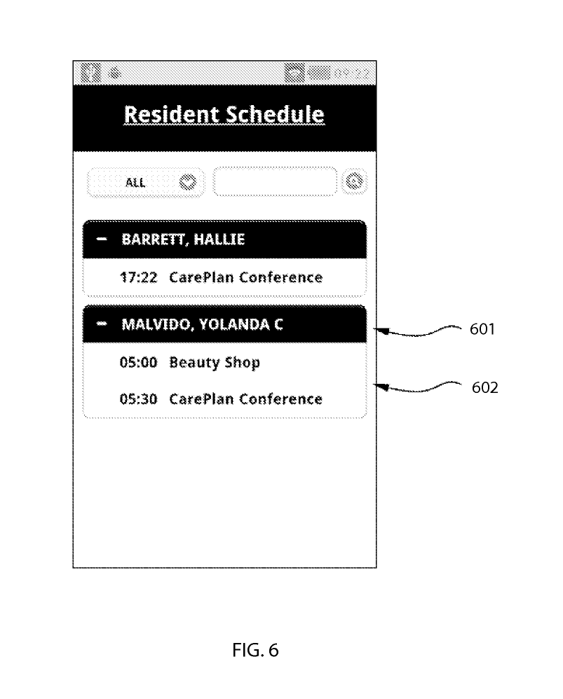

Referring to FIG. 6, in an embodiment, if the user selects periodic care for patients through the periodic care schedule 402 (FIG. 4), the care task data receiving and displaying unit 210 receives user-undertaken care tasks for the patients to be performed during a certain period from the patient care documentation server 110. For example, referring to FIG. 6, the care task data receiving and displaying unit 210 displays a one-day care schedule (e.g., from 12:00 a.m. to 12:00 p.m.) for patients who are to receive a periodic care service. The one-day care schedule may include at least one of a name 601 of a particular patient and care information 602 including a care service, scheduled by time, for the particular patient.

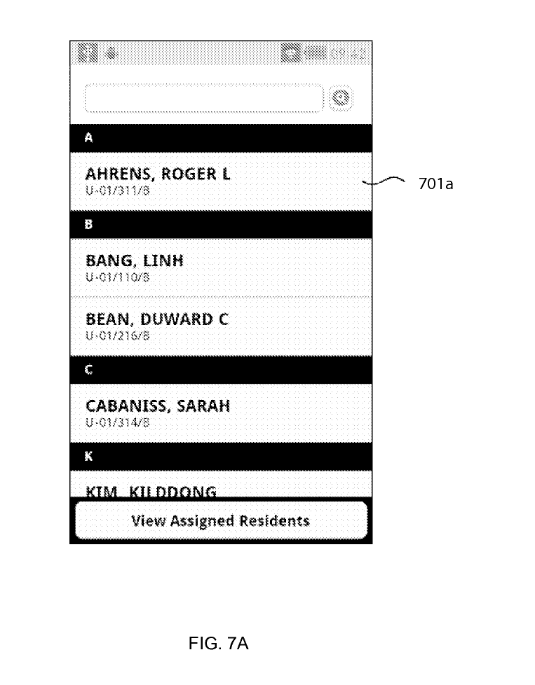

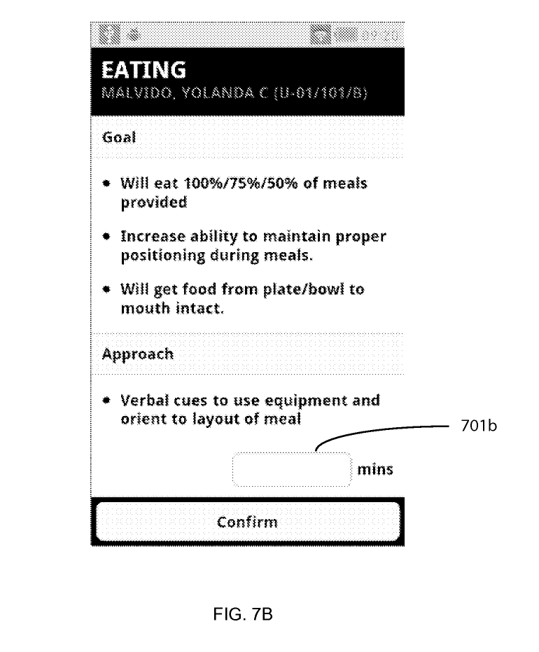

Referring to FIGS. 7A and 7B, in an embodiment, if the user selects the restorative schedule 403 (FIG. 4), the care task data receiving and displaying unit 210 receives a user-undertaken care task for restoring a health condition of a particular patient from the patient care documentation server 110. For example, when the restorative schedule 403 is selected and then a particular patient 701a is selected as shown in FIG. 7A, the care task data receiving and displaying unit 210 receives the user-undertaken care task for restoring the health condition of the particular patient 701a from the patient care documentation server 110. The care task data receiving and displaying unit 210 displays the received task, as illustrated in FIG. 7B, so that the user can perform the user-undertaken care task for the patient 701a. After performing the user-undertaken care task, the user may input a performance time of the user-undertaken care task using a time input field 701b shown in FIG. 7B.

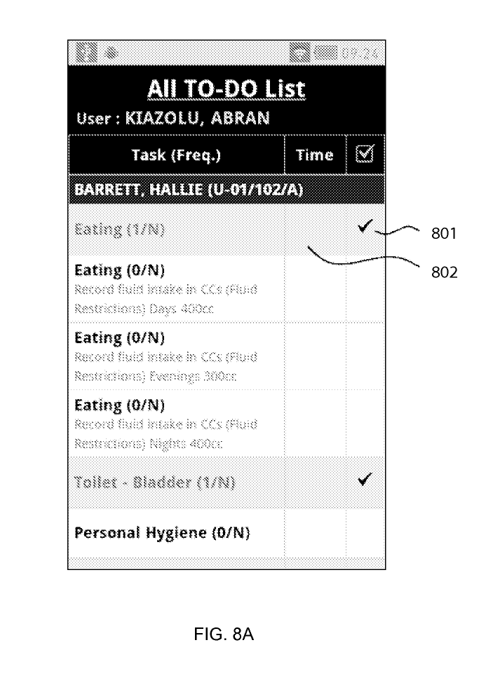

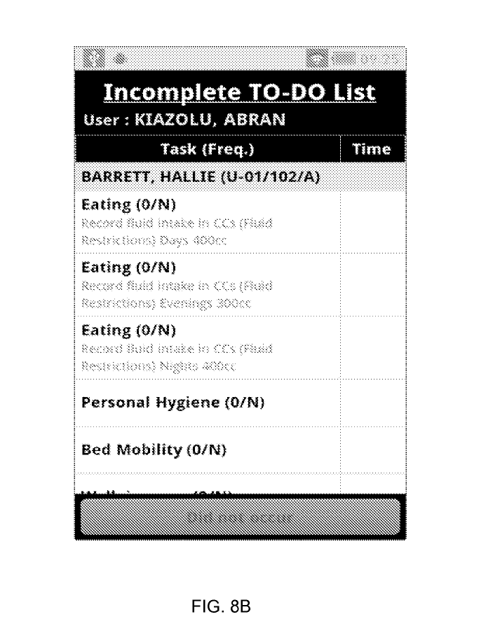

Referring to FIGS. 8A and 8B, in an embodiment, if the user selects the all information field 404 (FIG. 4), the care task data receiving and displaying unit 210 receives all user-undertaken care tasks from the patient care documentation server 110. If the user selects the incomplete information field 405, the care task data receiving and displaying unit 201 receives incomplete user-undertaken care tasks from the patient care documentation server 110. The user-undertaken care tasks for a particular patient may be managed through the all information field 404 and the incomplete information field 405.

For example, referring to FIG. 8A, if the all information field 404 including all user-undertaken care tasks assigned to the user is selected, at least one of the name of a particular patient, at least one user-undertaken care task for the particular patient, the number of times 801 to perform the user-undertaken care task, and a time 802 when the user-undertaken care task should be performed, is received from the patient care documentation server 110 and provided to the user. Referring to FIG. 8B, if the incomplete information field 405 including the incomplete user-undertaken care tasks is selected, at least one of a name of a particular patient, at least one user-undertaken care task that has not been performed for the particular patient, the number of times to perform the user-undertaking care task, and a time when the user-undertaken care task should be performed, is received from the patient care documentation server 110 and provided to the user.

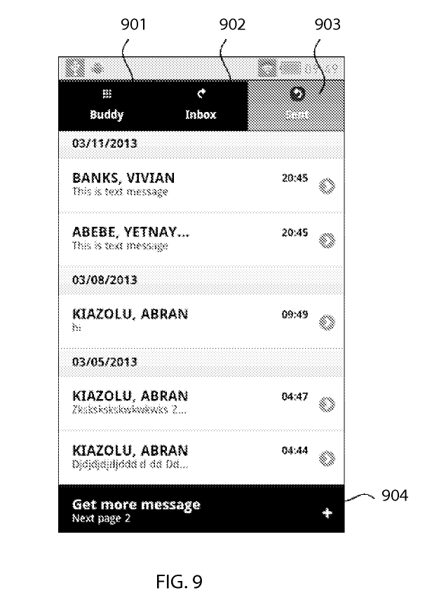

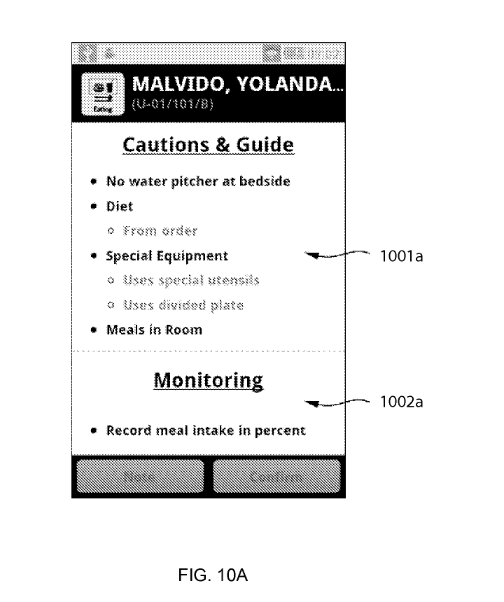

Referring to FIG. 9, in an embodiment, the care task data receiving and displaying unit 210 provides the message field 406 (FIG. 4) to allow the user to communicate with other users. For example, referring to FIG. 9, if the message field 406 shown in FIG. 4 is selected, a name of at least one of all users using patient care documentation devices, a location of at least one user, and an online or offline state of at least one user are provided through a buddy list 901. At least one time when a message was received, a name of a user who sent the message, and message content are provided through an inbox 902. At least one time when a message was sent, a name of a user who received the message, and message content are provided through a sent box (“Sent”) 903. More messages may be displayed by selecting a “Get more messages” field 904.

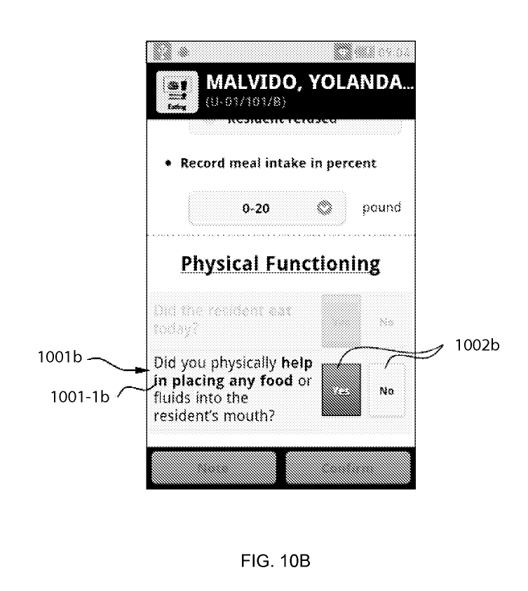

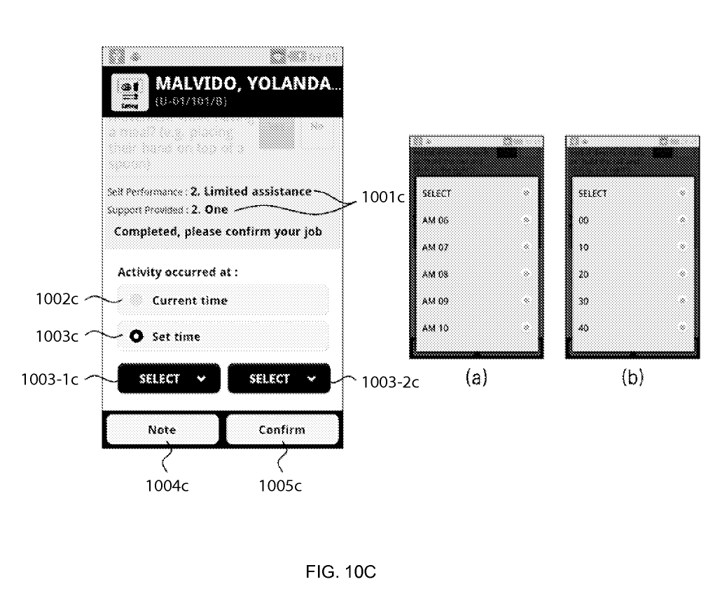

A method of patient care documentation according to an embodiment of the present invention will be described with reference to FIGS. 10A through 10C.

When a particular patient is selected and the user performs a corresponding user-undertaken care task for the patient, the answer receiving and processing unit 220 (FIG. 2B) provides a user interface for patient care documentation. In an embodiment, the answer receiving and processing unit 220 may implement a data tree structure that provides a progression of questions and answers. That is, in an embodiment, the answer receiving and processing unit 220 receives a flow answer selected in response to a progressing series of questions or queries. In an embodiment, the queries are provided by the answer receiving and processing unit 220 based on an input provided by the user. In an embodiment, a symbolic answer may be provided. The symbolic answer may be selected from among a plurality of symbolic expressions that indicate a user undertaken care task that the user is to perform.

In an embodiment, the answer receiving and processing unit 220 receives answers from the user through text queries for the user-undertaken care task. In an embodiment, the user selects one of a plurality of previously-defined answers to a query. The answer receiving and processing unit 220 receives from the user the answers through first to final text queries on the basis of a predefined progression of questions and answers. The answer receiving and processing unit 220 may determine a care task performance code by determining one of leaf nodes of the data tree. In other words, a care task performance code is determined based on an answer received in response to a query.

For example, referring to FIGS. 10A through 10C if the answer receiving and processing unit 220 provides a “Cautions & Guide” field 1001a for the user-undertaken care task, the user may record a condition of the particular patient through a “Monitoring” field 1002a. In an embodiment, the answer receiving and processing unit 220 may receive ‘Yes’ or ‘No’ answer 1002b from the user based on a text query 1001b with respect to the user-undertaken care task.

The answer receiving and processing unit 220 may check whether or not at least a portion of the text query 1001b has been formatted in a particular form. If a portion of the text query 1001b is determined to be formatted in a particular form, the answer receiving and processing unit 220 detects the formatting from the particular form. If the formatting is detected, the answer receiving and processing unit 220 renders (1001-1b) the text query 1001b according to the detected formatting. For example, the portion of the text query 1001b is rendered in bold or is rendered in a different color.

Referring to FIGS. 10B and 10C, upon receiving a Yes' or ‘No’ answer 1001b as an answer to the final text query, the answer receiving and processing unit 220 may determine a care task performance code 1001c for the particular patient.

When a request to change a selected answer is received from the user, the answer receiving and processing unit 220 may generate a higher node for the query answer flow. Namely, the answer receiving and processing unit 220 may generate a text query 1001b again such that Yes' or ‘No’ answer 1002b for the text query 1001b received from the user can be changed.

The answer receiving and processing unit 220 may tag a process time for the user-undertaken care task to the care task performance code. In an embodiment, a current time 1002c or a set time 1003c may be selected as the process time for the user-undertaken care task. The set time 1003c may be set through an hour selection 1003-1c and a minute selection 1003-2c. When the above selections are completed, the answer receiving and processing unit 220 may transmit information including the selections to the patient care documentation server 110. In an embodiment, the information is sent to the patient care documentation server 110 when the user selects a confirm control 1005c.

In addition, the answer receiving and processing unit 220 provides assistance records for the user-undertaken care tasks to the patient care documentation server 110 as the user inputs the assistance records. The assistance records include at least one of text and speech notes input by the user by selecting a note field 1004c.

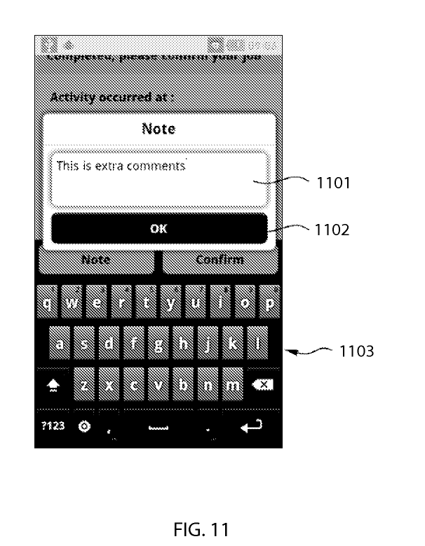

In an embodiment, referring to FIG. 11, the answer receiving and processing unit 220 receives the input assistance records 1101 for the user-undertaken care task as text written through a keypad 1103. The assistance records 1101 are stored in the patient care documentation server 110 when an OK control 1102 is selected.

In another embodiment, the answer receiving and processing unit 220 provides a plurality of symbolic expressions as answers to queries and allows the user to select one of the plurality of symbolic expressions. Here, the answer receiving and processing unit 220 may provide leaf nodes corresponding to the plurality of symbolic expressions.

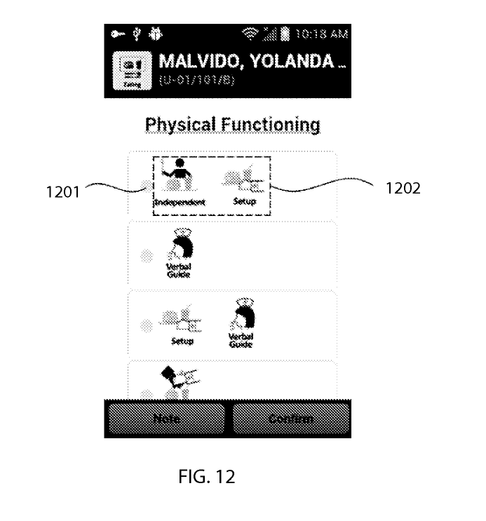

For example, referring to FIG. 12, if the user selects a particular symbolic expression (1201) among symbolic expressions 1202 of the user-undertaken care tasks, the answer receiving and processing unit 220 receives the selected symbolic expression as a symbolic answer to a query. Meanwhile, the answer receiving and processing unit 220 may tag a process time for the user-undertaken care tasks to the care task performance code. At this time, the answer receiving and processing unit 220 may tag the process time for the user-undertaken care tasks to the care task performance code in the manner described above with reference to FIG. 10C.

The care record providing unit 230 provides the received answers to the patient care documentation server 110.

In an embodiment, if a late care service message for user-undertaken care tasks is received from the patient care documentation server 110, the late care service requesting unit 240 (FIG. 2B) requests the user to perform (process or provide) a late care service by changing a state of the patient care documentation device 120-2. For example, the late care service requesting unit 240 sets a predetermined time to 10 minutes and changes the device state by vibrating the patient care documentation device 120-2 or by sounding an alarm message or signal. After that, if the user recognizes the change of the device state, the user may perform the late care service and initiate a query and answer progression corresponding to the late care service. Once the answers to the progression of questions are received, the care record providing unit 230 transmits the received answers to the patient care documentation server 110.

In an embodiment, if a certain user-undertaken care task is not performed for a predetermined period of time and the urgent care service requesting unit 250 (FIG. 2B) receives an urgent care service message for the certain user-undertaken care task from the patient care documentation server 110. The urgent care service requesting unit 250 requests the user to perform the urgent care service by changing a device state. For example, the urgent care service requesting unit 250 sets a predetermined time to 10 minutes and changes the device state by vibrating the patient care documentation device 120-2 or by sounding an alarm message or signal. After that, if the user recognizes the change of the device state, the user may perform the urgent care service and initiate a query and answer progression corresponding to the urgent care service. Once input answers are received, the care record providing unit 230 transmits the received answers to the patient care documentation server 110. The controller 260 (FIG. 2B) controls operations of the components shown in FIG. 2B. For example, the controller 260 controls a control flow or a data flow among the care task data receiving and displaying unit 210, the answer receiving and processing unit 220, the care record providing unit 230, the late care service requesting unit 240, and the urgent care service requesting unit 250 shown in FIG. 2B.

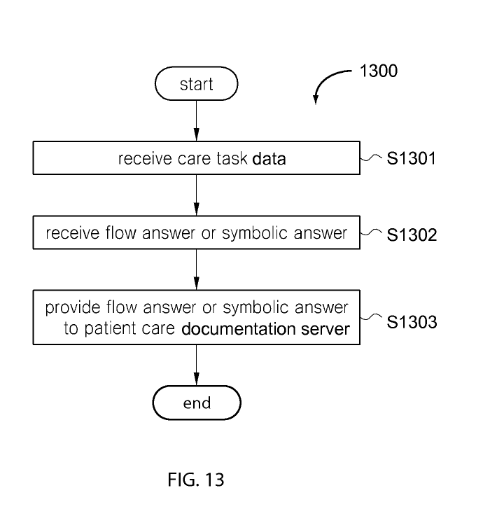

FIG. 13 is a process 1300 illustrating a patient care documentation method according to an embodiment of the present invention.

Referring to FIG. 13, the care task data receiving and displaying unit 210 receives care task data including user-undertaken care tasks from the patient care documentation server 110 (S1301). Here, user-undertaken care task data may include at least one of a name of a particular patient, the number of times to perform the user-undertaken care task, and a time when the user-undertaken care task should be performed.

In an embodiment, the care task data is visualized or displayed using at least one of the personal care schedule 401, the periodic care schedule 402, the restorative schedule 403, the all information field 404 regarding all user-undertaking care tasks assigned to a user, the incomplete information field 405 regarding incomplete user-undertaking care tasks among the user-undertaking care tasks, and the message field 406.

If a particular patient is selected and the user performs user-undertaken care tasks for the particular patient, the answer receiving and processing unit 220 receives from the user a selected flow answer or a symbolic answer selected from among a plurality of symbolic expressions (S1302).

In an embodiment, the answer receiving and processing unit 220 receives selected answers from the user through text queries for the user-undertaken care tasks. Here, the answer receiving and processing unit 220 may receive answers from the user in response to first to final text queries on the basis of a predefined query and answer progression.

The answer receiving and processing unit 220 may determine a care task performance code by determining one of leaf nodes for the query and answer progression based on the received answers.

In another embodiment, the answer receiving and processing unit 220 provides a plurality of symbolic expressions for the user-undertaken care tasks, thus allowing the user to select one of the plurality of symbolic expressions as an answer in the query and answer progression. The answer receiving and processing unit 220 may provide leaf nodes as part of the plurality of symbolic expressions.

The care record providing unit 230 provides a received answer to the patient care documentation server 110 (S1303), and the process 1300 is terminated.

In an embodiment, if a late care service message for user-undertaken care tasks is received from the patient care documentation server 110, the late care service requesting unit 240 requests the user to perform (process or provide) a late care service by changing a device state.

In an embodiment, if there are other user-undertaken care tasks that have not been performed for a particular period of time, the urgent care service requesting unit 250 receives an urgent care service message for the other user-undertaken care tasks from the patient care documentation server 110, and requests the user to perform the urgent care service by changing the device state.

The processes for the late care service and the urgent care service may be selectively executed as described above with reference to the late care service requesting unit 240 and the urgent care service requesting unit 250. After that, S1301 through S1303 shown in FIG. 13 may be performed for the late care service or the urgent care service.

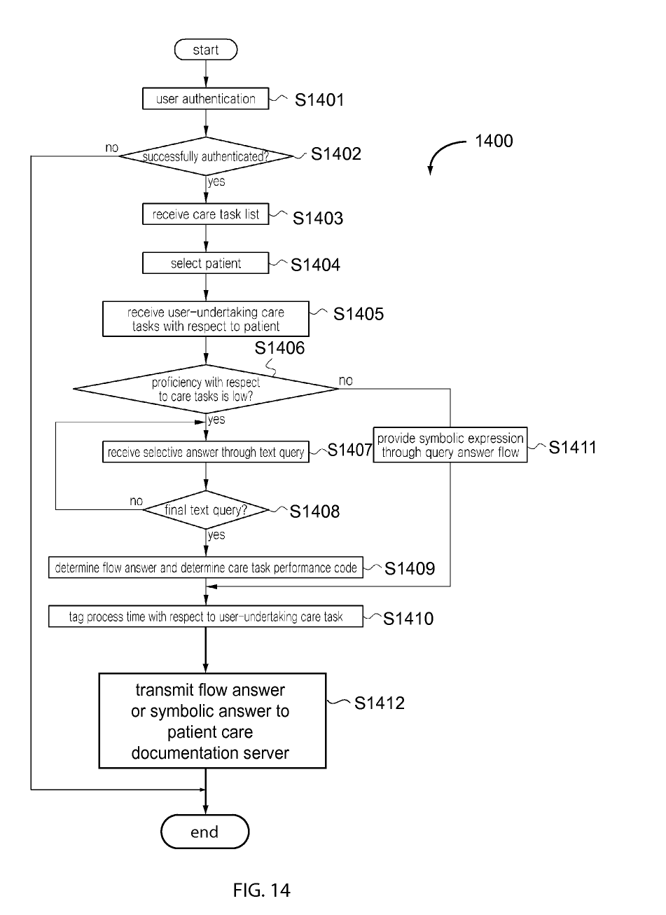

FIG. 14 is a process 1400 illustrating a patient care documentation method according to an embodiment of the present invention.

Referring to FIG. 14, the patient care documentation server 110 authenticates a user (S1401). For example, when log-in information including a user identification (ID) and a user password (e.g., personal identification number (PIN)) is received through the patient care documentation device 120, the patient care documentation server 110 performs user authentication.

If the user is successfully authenticated at S1402, the care task data receiving and displaying unit 210 receives care task data (S1403). On the other hand, if the user is not authenticated, this process is terminated.

In an embodiment, the care task data is visualized or displayed using at least one of a personal care schedule, a periodic care schedule, a restorative schedule, an all information field, an incomplete information field, and a message field.

The care task data receiving and displaying unit 210 prompts selection of one a plurality of patients assigned to the user through the personal care schedule (S1404).

When a particular patient is selected through prompting step S1404, the care task data receiving and displaying unit 210 receives a user-undertaken care task for the particular patient from the patient care documentation server 110 (S1405). In an embodiment, display of the user-undertaken care task may include at least one of an icon indicating the user-undertaken care task, a name of the user-undertaken care task, the number of times to perform the user-undertaken care task, and a time when the user-undertaken care task should be performed.

The answer receiving and processing unit 220 determines proficiency (or a competence level) of the user with respect to the user-undertaken care tasks and provides a text query or a symbolic expression based on the user proficiency (S1406).

If the user proficiency is low, the answer receiving and processing unit 220 receives answers through text queries for the user-undertaken care tasks (S1407). The answer receiving and processing unit 220 receives from the user the answers for first to final text queries on the basis of a predefined query and answer progression at S1408, the answer receiving and processing unit 220 determines a care task performance code by determining one of leaf nodes for the query and answer progression (S1409).

If the user proficiency is not low, i.e., relatively high, the answer receiving and processing unit 220 provides a plurality of symbolic expressions in the query and answer progression to allow the user to select one of the plurality of symbolic expressions (S1411). Here, the leaf nodes in the query and answer progression may be provided as part of the plurality of symbolic expressions.

After that, the answer receiving and processing unit 220 tags a process time for the user-undertaken care tasks to the care task performance code (S1410).

In an embodiment, a current time or a set time is selected as the process time for the user-undertaken care tasks. The set time may be set using an hour selection field and a minute selection field.

Subsequently, the care record providing unit 230 transmits a received flow answer or symbolic answer to the patient care documentation server 110 at S1412, and the process 1400 is terminated.

Optionally, if a late care service message for a certain user-undertaken care task is received from the patient care documentation server 110, the late care service requesting unit 240 requests the user to perform (process or provide) a late care service by changing a device state.

If a certain user-undertaken care task is not performed for a particular period of time and thus an urgent care service message for the certain user-undertaken care task is received from the patient care documentation server 110, the urgent care service requesting unit 250 requests the user to process the urgent care service by changing a device state.

In an embodiment, the late care service requesting unit 240 and the urgent care service requesting unit 250 may set a predetermined time to 10 minutes and change the device state by vibrating the patient care documentation device 120 or by sounding a message alarm.

In embodiments of the present invention, the foregoing methods may be implemented as codes that can be read by a computer and stored on a computer-readable medium. The computer-readable medium may include any type of recording device in which data that can be read by a computing system is stored. The computer-readable medium may include a ROM, a RAM, a CD-ROM, a magnetic tape, a floppy disk, an optical data storage device, and the like. The computer-readable recording medium may be distributed over network-coupled computer systems so that the computer-readable code may be stored and executed in a distributed fashion.

While the present invention has been shown and described in connection with various embodiments, it will be apparent to those skilled in the art that modifications and variations can be made without departing from the spirit and scope of the invention as defined by the appended claims.

What is claimed is:

1. A patient care documentation method comprising:
receiving care task data including user-undertaken care tasks from a patient care documentation server;
receiving a selected answer in response to a text query or a symbolic answer selected from a plurality of symbolic expressions, the text query or the plurality of symbolic expressions corresponding to processes of performing the user-undertaken care tasks; and
transmitting the selected answer or symbolic answer to the patient care documentation server.

2. The patient care documentation method of claim 1, wherein the care task data comprises at least one of a personal care schedule and a periodic care schedule associated with the user-undertaken care task.

3. The patient care documentation method of claim 2, wherein receiving the care task data comprises:
prompting selection of a particular patient among patients assigned to a user through the personal care schedule; and
receiving user-undertaken care tasks for the particular patient from the patient care documentation server when the particular patient is selected.

4. The patient care documentation method of claim 2, wherein receiving the care task data comprises:
prompting selection of a certain patient care time through the periodic care schedule; and
receiving user-undertaken care tasks for a particular patient to be performed at the certain patient care time from the patient care documentation server when the certain patient care time for the particular patient is selected.

5. The patient care documentation method of claim 1, wherein receiving the selected answer comprises:
receiving a plurality of selected answers from a user in response to a corresponding progression of text queries regarding the user-undertaken care tasks on the basis of a predefined query and answer progression.

6. The patient care documentation method of claim 5, wherein receiving the selected answer further comprises:
when a change request with respect to the received plurality of selected answers is received from the user, generating an upper node for the predefined query and answer progression through a text query.

7. The patient care documentation method of claim 6, wherein receiving the selected answer further comprises:
determining one of leaf nodes for the predefined query and answer progression as the selected answer based on the received plurality of selected answers, and determining a care task performance code.

8. The patient care documentation method of claim 6, wherein receiving the selected answer comprises:
checking whether or not a portion of the text queries has been formatted in a particular form; and
when it is determined that the portion of the text queries has been formatted in the particular form, detecting a formal language through the particular form and rendering a modified text query according to the detected formal language.

9. The patient care documentation method of claim 7, further comprising:
tagging a process time of the user-undertaken care tasks to the care task performance code.

10. The patient care documentation method of claim 1, wherein receiving the symbolic answer comprises:
receiving one of the plurality of symbolic expressions through a query and answer progression with respect to the user-undertaken care tasks.

11. The patient care documentation method of claim 10, wherein receiving the symbolic answer further comprises:
providing leaf nodes in the query and answer progression as the plurality of symbolic expressions.

12. The patient care documentation method of claim 11, further comprising:
tagging a process time of the user-undertaken care tasks to a care task performance code.

13. The patient care documentation method of claim 1, further comprising:
if a late care service message with respect to the user-undertaken care tasks is received from the patient care documentation server, requesting a user to perform a late care service by changing a device state.

14. The patient care documentation method of claim 1, further comprising:
if there is a certain user-undertaken care task that is not performed for a particular period of time and an urgent care service message with respect to the certain user-undertaken care task is received from patient care documentation server, requesting a user to perform an urgent care service by changing a device state.

15. The patient care documentation method of claim 1, further comprising:
providing assistance records with respect to the user-undertaken care tasks through at least one of text and speech to the patient care documentation server.

16. The patient care documentation method of claim 1, further comprising:
performing user authentication with a user through the patient care documentation server before receiving the care task data.

17. A system for generating patient care documentation, the system comprising:
a processor;
a network interface;
a user interface; and
a non-transitory computer readable medium including instructions for performing the following steps:
receiving care task data including user-undertaken care tasks from a patient care documentation server and displaying the care task data;
receiving an answer selected in response to a text query in a query and answer progression or a symbolic answer selected from a plurality of symbolic expressions, the text query or the plurality of symbolic expressions corresponding to processes of performing the user-undertaken care tasks; and
providing the received answer or symbolic answer to the patient care documentation server.

18. The system of claim 17, wherein the non-transitory computer readable medium further includes instructions for requesting the user to perform a late care service by changing a device state when a late care service message with respect to the user-undertaken care tasks is received from the patient care documentation server.

19. The system of claim 17, wherein the non-transitory computer readable medium further includes instructions for receiving an urgent care service message with respect to a certain user-undertaken care task from the patient care documentation server when the certain user-undertaken care task is not performed for a particular period of time, and requesting the user to perform an urgent care service by changing a device state.

20. A computer readable medium having a computer program for causing a computer to perform patient care documentation, the computer readable medium comprising:
code for receiving care task data including user-undertaken care tasks from a patient care documentation server;
code for receiving an answer selected in response to a text query in a query and answer progression or a symbolic answer selected from a plurality of symbolic expressions, the text query or the plurality of symbolic expressions corresponding to processes of performing the user-undertaken care tasks; and
code for providing the received answer or symbolic answer to the patient care documentation server.
